(19) United States
(12) Patent Application Publication
(10) Pub. No.: US 2024/0395126 A1
(43) Pub. Date: Nov. 28, 2024

(54) NOTIFICATION APPARATUS, SYSTEM, AND PROGRAM

(71) Applicant: NIPPON TELEGRAPH AND TELEPHONE CORPORATION, Tokyo (JP)

(72) Inventors: Toshimitsu TANAKA, Tokyo (JP); Toru TANAKA, Tokyo (JP); Toshihiro HAYASHI, Tokyo (JP)

(21) Appl. No.: 18/717,038

(22) PCT Filed: Dec. 14, 2021
(86) PCT No.: PCT/JP2021/046097

§ 371 Date: Jun. 6, 2024

(51) Int. Cl. G08B 21/24; B60L 53/16; G07C 5/02

(52) U.S. Cl. CPC G08B 21/24; G07C 5/02; B60L 53/16

(57) ABSTRACT

A notification apparatus includes circuitry configured to detect that an electric vehicle has stopped; detect that a vehicle connector has not been connected to the electric vehicle after locking a door of the electric vehicle; determine that a user is promoted to connect the vehicle connector to the electric vehicle, upon detecting that the electric vehicle has stopped and detecting that the vehicle connector has not been connected to the electric vehicle; and present a notification to the user to prompt the user to connect the vehicle connector.

### TECHNICAL FIELD

The present invention relates to a technique for preventing an event of forgetting to connect a vehicle connector of a charging cable to an EV.

### BACKGROUND ART

In recent years, types of vehicles have diversified, and vehicles in which storage batteries are utilized, such as electric vehicles (EVs), and plug-in hybrid electric vehicles (PHEVs) have been introduced for the purpose of considering the environment. Hereinafter, vehicles in which storage batteries are utilized are generally referred to as EVs.

In order to smoothly operate the EV on a daily basis, it is important not to forget to execute a charging operation on a daily basis. EV utilization is diversifying, and efforts to effectively use EVs have started, such as utilization of a peak cut, a peak shift, virtual power plant (VPP), or utilization of a demand response (DR) of a building using an EV as a stationary battery or lease use of a car for a company at the weekend.

When an EV is used in this way, the EV and an EV charger (or a charging/discharging device) cannot be utilized as necessary for charging or a stationary storage battery unless a charging cable is connected to the EV and the EV charger.

In this way, if connecting the charging cable is forgotten, there is a case where a function expected for the EV cannot be executed. Therefore, a user is required not to forget to appropriately execute an action of connecting the charger and the EV by a vehicle connector of the charging cable.

The importance of charging is due to the diverse uses of EVs. With regard to this, there is EV company vehicle use (corporate use). In other words, as an effort toward decarbonization, companies have actively introduced EVs and used them for business purposes.

When companies use EVs in business on a daily basis, it is necessary to charge the EVs with power necessary for business (necessary for traveling) in advance. However, since the number of vehicles for the companies is large and the charging takes several hours, it is necessary to ensure that the vehicles are charged when they are not being used for business.

If charging cannot be performed, there is a possibility that business will not be able to be conducted the next day, due to the time taken for EV charging. Therefore, an EV charging system and an EV are required to be reliably connected by a charging cable and a vehicle connector.

In recent years, vehicle to grid (V2G) and vehicle to building (V2B) in which EV storage batteries are handled as stationary storage batteries have come to be expected to be used as one of building power facilities performing peak cut or the like. However, it is also necessary to reliably connect EV charging/discharging devices to EVs.

As described above, it is expected to use storage batteries of EVs, such as V2X (V2B (peak cut of building) and V2G (contribution to system stabilization), for VPP in which the storage batteries of the EVs are used. However, even when V2X is used, the function is not carried out if connection of cables is not forgotten. When V2X is used for a demand response (DR), discharging cannot be performed unless EVs and EV charging/discharging systems are connected. Therefore, a power capacity (contracted capacity) required for the DR is not achieved and penalty has to be paid.

As described above, since EVs, EV charging systems, and charging/discharging systems which are being stopped in parking lots are required to be reliably connected to each other by cables and to be in states in which charging or discharging can be performed, it is necessary to pay attention to prevent the cables from being forgotten to be inserted.

### CITATION LIST

### Non Patent Literature

NPL 1: http://www.nissan.co.jp/OPTIONAL-PARTS/NAVIOM/LEAF/NAVI/1112_CONTENTS/guid-5e39866f-5ec8-4cb3-acad-0a5acca0c919.html), retrieved on Nov. 26, 2021

### SUMMARY OF INVENTION

### Technical Problem

NPL 1 discloses a function of notifying a user of forgetting of insertion of a vehicle connector in an electric vehicle by mail when the vehicle connector is not inserted after the user stops at a registered point and a predetermined time has passed (NPL 1). However, in the case of this function, it is difficult to notify the user at an appropriate timing.

The present invention has been devised in view of the foregoing circumstances and an object of the present invention is to provide a technique for notifying a user of forgetting of insertion of a vehicle connector in an electric vehicle by the user at an appropriate timing and prompts the user to connect the vehicle connector.

### Solution to Problem

According to the disclosed technique, a notification apparatus includes: a processing unit configured to detect that an electric vehicle has stopped and determine to prompt a user to connect a vehicle connector when it is detected that the vehicle connector has not been connected to the electric vehicle after door locking of the electric vehicle; and a notification unit configured to give a notification to the user to prompt the user to connect the vehicle connector.

### Advantageous Effects of Invention

According to the disclosed technique, it is possible to provide a technique for notifying a user of forgetting of insertion of a vehicle connector in an electric vehicle by the user at an appropriate timing and prompts the user to connect the vehicle connector.

### BRIEF DESCRIPTION OF DRAWINGS

FIG. 1 is a diagram illustrating a system configuration according to an embodiment of the present invention.

FIG. 2 is a flowchart illustrating processing according to the embodiment of the present invention.

FIG. 3 is a diagram illustrating an example of a hardware configuration of a device.

### DESCRIPTION OF EMBODIMENTS

Hereinafter, an embodiment of the present invention (present embodiment) will be described with reference to the accompanying drawings. The embodiments to be described below are merely exemplary, and embodiments to which the present invention is applied are not limited to the following embodiments.

### Terms

Before operations and operations according to the embodiment are described, main terms according to the embodiment will be first described.

“EV” is an electric vehicle. A “vehicle” includes a motorcycle and an agricultural tractor in addition to a passenger car, a truck, and the like.

An “EV charger” is a device or a combination of devices providing dedicated functions of supplying power from a power supply network to an EV or allowing reverse flow of power for the purpose of charging or discharging.

An “EV charging system” is an entire system including an EV charger and an EV function required to supply power to an EV for charging. A “charging cable” is a cable for connection to an EV and allowing charging thereof with an EV charger to an EV and also includes a charging/discharging cable. The cable is an electric wire in which a power supply line and a signal line are combined.

“V2X” is a function of charging and discharging an EV. An “EV charging/discharging system (V2X system)” is an entire system including bidirectional power supply devices and functions necessary for performing V2X (vehicle to everything).

A “control pilot function” is a function used to monitor and control an interaction between an EV and an EV charger. A “control pilot circuit” is a circuit designed for signal transmission or communication between an EV and an EV charger.

A “vehicle connector (also called a charging connector)” is a connection mechanism adapted to an eligible standard such as IEC 62196-3 Standard Sheets Configuration AA mounted on a charging cable.

A “proximity function” is electrical or mechanical means indicating that a vehicle connector (charging connector) is inserted into a vehicle inlet of an EV, and/or electrical or mechanical means indicating that a connector is inserted into a socket of an EV charging stand.

### Overview of Embodiment

In the present embodiment, a technique for giving a notification (connection request) to prompt a user to connect a connector at an appropriate timing in order to prevent an event that the user who needs charging and discharging of an EV forgets to connect a vehicle connector of a charging cable to the EV will be described. A function of notifying a connection request in the present embodiment is implemented by adding a notification system to be described below to a charger side device without revising an EV side. Communication between the EV charger and the notification system can be performed by CHAdeMO, ECHONET (registered trademark) LIGHT, OCPP, SEP, or the like. In the present embodiment, any method may be used. Hereinafter, examples of a system configuration and an operation will be described in detail.

### (System Configuration)

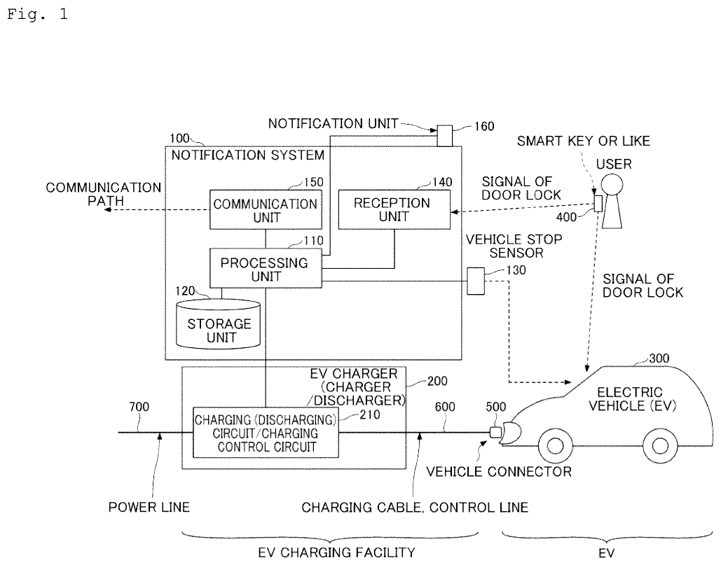

FIG. 1 illustrates an example of an overall configuration of a system according to the present embodiment. FIG. 1 illustrates a configuration of an EV charging facility side, an EV 300, a user holding a device 400 such as a smart key.

The EV charging facility side includes a notification system 100 and an EV charger 200. Since the EV charger 200 may have a discharging function (that is, may be a charger/discharger), the EV charger 200 is referred to as an EV charger (charger/discharger) in FIG. 1. The EV charger 200 includes a charging (discharging) circuit and a charging control circuit as an internal functional unit 210. A charging cable 600 (including a control line) including a vehicle connector 500 extends from the EV charger 200. A power line 700 connected to a power supply by regenerative energy generation or a commercial power supply is illustrated.

As illustrated in FIG. 1, the notification system 100 includes a processing unit 110, a storage unit 120, a vehicle stop sensor 130, a reception unit 140, a communication unit 150, and a notification unit 160. The notification system 100 may also be called “notification apparatus”. The processing unit 110, the storage unit 120, the reception unit 140, the communication unit 150, and the notification unit 160 may also be referred to as a processing device, a storage device, a reception device, a communication device, and a communication device, respectively. The processing unit 110 may also be called a processor.

The reception unit 140 has a function of receiving a weak door lock signal from a device 400 (a smart key, a keyless entry key, or the like) capable of remotely locking a door of the EV 300.

The storage unit 120 stores a feature of the door lock signal so that the door lock signal of the EV 300 which is a target can be identified. This “feature” may also be referred to as identification information. The processing unit 110 communicates with a charging control circuit 210 of the EV charger 200, and has a function of receiving connection information of the charging cable 600.

The processing unit 110 has a function of determining whether the door lock signal from the reception unit 140 is a signal of the EV 300 of a target user by comparing the door lock signal with the identification information read from the storage unit 120.

The processing unit 110 performs AND condition processing for determining whether a condition of a notification to the user is satisfied. The details of the AND condition processing will be described below.

The notification unit 160 gives a notification to a user to prompt connection of the charging cable to the EV 300. The notification may be executed by any means.

For example, when the notification unit 160 physically gives the notification to the user, the notification unit 160 is a lamp for emitting light, a speaker for emitting a warning sound, an element for transmitting a sound by vibration, a panel for displaying text, or the like. In this case, it is assumed that a distance between the user and the notification unit 160 is short.

For example, when the notification unit 160 gives a notification to a terminal (a smartphone or the like) of a user, for example, the notification unit 160 has a function of notifying the portable terminal such as a smartphone through radio communication. As for a notification in which radio communication is used, the notification can be performed via any network such as a carrier line, the Internet, and short-range wireless network (for example, Bluetooth (registered trademark) or the like), or a network in which they are combined.

The communication unit 150 has a function of transmitting information such as the state information, processing content, and an error to a management device or the like. The vehicle stop sensor 130 has a function of detecting that the EV 300 is stopped in a parking space. For example, by using a distance sensor, it is possible to determine whether the EV 300 has stopped in a parking space in accordance with a distance between the distance sensor and the EV 300. This is also exemplary. For example, by using a video of a camera imaging the parking space, it may be determined whether the EV 300 has stopped in the parking space.

### System Operation Example

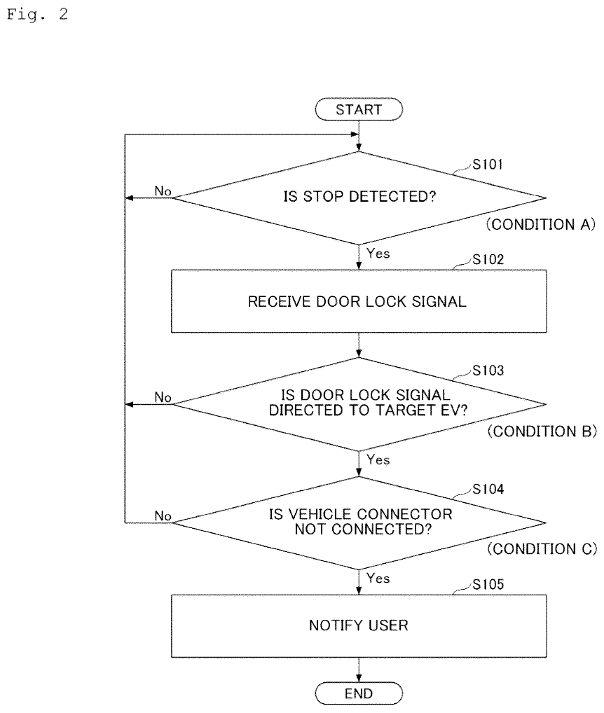

An operation example of the notification system 100 according to the present embodiment will be described below with reference to the flowchart of FIG. 2.

In step S101 (step 101), the processing unit 110 determines whether the EV 300 has stopped in a parking space. Specifically, when the EV 300 has stopped in the parking space, the vehicle stop sensor 130 detects the EV 300 and transmits information indicating the detection of the stopping to the processing unit 110 as a flag.

The processing unit 110 periodically monitors information from the vehicle stop sensor 130 and determines that the EV 300 has stopped in the parking space when the information indicating the detection of the stopping is received. Here, a condition A is that “the EV 300 has stopped in the parking space”.

When YES is determined in S101 (when the EV 300 has stopped in the parking space), the processing moves to S102. Here, it is assumed that the user locks a door using the device 400 when the EV 300 has stopped.

In S102, the reception unit 140 receives the door lock signal transmitted from the device 400 of the user. The signal is delivered to the processing unit 110.

In S103, the processing unit 110 compares the signal transmitted from the reception unit 140 with data in the storage unit 120, and determines whether the received door lock signal is directed to the EV 300 of the user who is a notification target. That is, it is determined whether the user has performed the door lock operation of the target EV 300.

Here, a condition B is that “the door lock signal is directed to the EV 300 of the user who is the notification target (or the user performs the door lock operation of the EV 300 which is a target)”. When the determination of S103 is Yes (the door lock operation is performed), the processing moves to S104.

In S104, the processing unit 110 communicates with a charging control circuit (which may be referred to as a control device) of the EV charger 200, inquires of the charging control circuit about whether the vehicle connector 500 is connected to the EV 300, and confirms whether the vehicle connector 500 has not been connected. A condition C is that “the vehicle connector 500 has not been connected”.

Although a method of detecting whether the vehicle connector 500 has reliably been connected to the EV 300 is not limited to a specific method, for example, there are a control pilot function, a control pilot circuit, a proximity function, and a method of holding latch in accordance with CHAdeMO and a confirming energization in conformity with IEC61851 “conductive charging system of an electric vehicle”.

When the determination in S104 is Yes (when the vehicle connector 500 has not been connected to the EV 300), the processing moves to S105.

In S105, the processing unit 110 determines that the conditions A, B and C are simultaneously satisfied. When the conditions A, B, and C are simultaneously satisfied, the processing unit 110 determines to prompt the user to connect the vehicle connector, the notification unit 160 is operated to notify the user that the vehicle connector has not been connected. Accordingly, the user can be aware that the user has forgotten to insert the vehicle connector, and connects the vehicle connector to the EV 300.

### (Hardware Configuration Example)

The notification system 100 can be implemented, for example, by causing a computer to execute a program. The computer may be a physical computer or a virtual machine on a cloud. In the notification system 100 illustrated in FIG. 1, units other than the notification unit 160 and the vehicle stop sensor 130 may be implemented by the computer.

Either or both of the notification unit 160 and the vehicle stop sensor 130 may be separated from the computer and connected via a network. For example, the computer may be located on a center side, and either or both of the notification unit 160 and the vehicle stop sensor 130 may be provided near a parking space.

That is, the notification system 100 can be implemented by executing a program corresponding to the processing that is performed by the notification system 100 using hardware resources such as a CPU and memory built into the computer. The program can be recorded on a computer-readable recording medium (a portable memory or the like) to be stored or distributed. The program can also be provided via a network such as the Internet or an electronic mail.

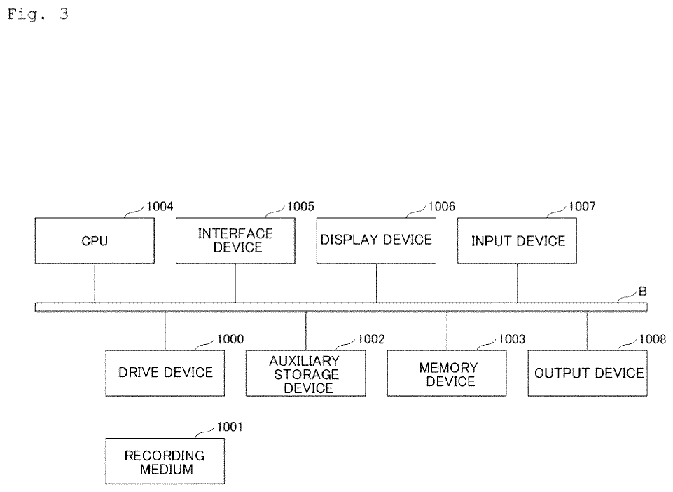

FIG. 3 is a diagram illustrating an exemplary hardware configuration of the computer. The computer illustrated in FIG. 3 includes a drive device 1000, an auxiliary storage device 1002, a memory device 1003, a CPU 1004, an interface device 1005, a display device 1006, an input device 1007, and an output device 1008 connected to each other via a bus B.

The program implementing the processing in the computer is provided by, for example, a recording medium 1001 such as a CD-ROM or a memory card. When the recording medium 1001 storing the program is set in the drive device 1000, the program is installed from the recording medium 1001 to the auxiliary storage device 1002 through the drive device 1000. Here, the program need not necessarily be installed from the recording medium 1001 and may be downloaded from another computer via a network. The auxiliary storage device 1002 stores the installed program and also stores necessary files, data, and the like.

The memory device 1003 reads and stores the program from the auxiliary storage device 1002 when an instruction to start the program is given. The CPU 1004 implements a function related to the notification system 100 in accordance with the program stored in the memory device 1003. The interface device 1005 is used as an interface for connection to a network or various devices (for example, an EV charger). The display device 1006 displays a graphical user interface (GUI) or the like according to the program. The input device 1007 is configured with a keyboard and a mouse, buttons, a touch panel, or the like and is used for inputting various operation instructions. The output device 1008 outputs a calculation result.

### Effects of Embodiment

According to the technique according to the present embodiment, it is possible to notify the user that the user has forgotten to insert the vehicle connector in the electric vehicle at an appropriate timing, and to prompt the user to connect the vehicle connector.

Here, the technique according to the present embodiment is different from the technique disclosed in NPL 1, and it will be described in detail that a user can be notified at an appropriate timing.

In the technique disclosed in NPL 1, the user sets two conditions, (1) a stop at a registered place and (2) a lapse of a set confirmation time. When these conditions are not satisfied, the user is not notified that the user has forgotten to insert the vehicle connector.

That is, in the technique of NPL 1, since the notification condition is set for a time and a place, a notification of forgetting of the insertion of the vehicle connector cannot be given in accordance with daily diverse cases.

The technique of NPL 1 has a problem that an unnecessary notification can be delivered to a user. For example, even in a scene in which a user is not interested in charging and awaits a person in a vehicle, a notification of forgetting of insertion of the connector is delivered after a set time has passed. Such a notification is troublesome and unnecessary for the user.

Further, when the set time until the notification is set to be long, a user has already been away from the parking lot. Therefore, the user who has received the notification comes to the EV in the parking lot again, which causes time waste.

As described above, in the known technique disclosed in NPL 1, the purpose of notifying a user at a timing appropriate for the user is not achieved, and thus there is a problem that the user feels discomfort in the notification and the effect of the notification is low. When a timing is not appropriate even if the notification is received, the user feels troublesome, and there remains a possibility of the forgetting of the insertion of the connector not being unsolved. This is a major problem because the purpose of the notification cannot be achieved.

Unlike the known technique disclosed in the above-described NPL 1, according to the technique according to the present embodiment, a notification is not given at a set time, but a notification is given when detecting that the vehicle connector has not been connected after locking of a door. Therefore, the notification can be given at an accurate timing before the user leaves the vehicle and an unnecessary notification such as a notification when the user is in the vehicle is not given.

Accordingly, implementation accuracy of connection between the EV and the charging vehicle connector can be improved, and reliable charging and discharging of the EV can be expected. Since charging and discharging of the EV can be controlled, an improvement of an energy reuse rate can be expected by controlling a timing of charging. Further, at a stage in which a schedule for building users is generated, EV charging amount management can be performed in accordance with a request of DR, VPP, or the like. Therefore, implementation accuracy of EV use (including DR and VPP) in V2X is improved.

### Appendix

The present specification discloses at least a notification apparatus, a system, and a program according to the following causes.

### Clause 1

A notification apparatus comprising:
a processing unit configured to detect that an electric vehicle has stopped and determine to prompt a user to connect a vehicle connector when it is detected that the vehicle connector has not been connected to the electric vehicle after door locking of the electric vehicle; and
a notification unit configured to give a notification to the user to prompt the user to connect the vehicle connector.

### Clause 2

The notification apparatus according to Clause 1, wherein the processing unit determines whether the door locking of the electric vehicle has been performed using a door lock signal from a device held by the user.

### Clause 3

The notification apparatus according to Clause 1 or 2, wherein the notification unit gives a notification to prompt the user to connect the vehicle connector using light, a sound, text, vibration, or radio communication.

### Clause 4

The notification apparatus according to any one of Clauses 1 to 3, wherein the processing unit determines whether the electric vehicle has stopped in a parking space based on a signal from a vehicle stop sensor.

### Clause 5

A system comprising:
the notification apparatus according to any one of Clauses 1 to 4; and
the electric vehicle.

### Clause 6

A program causing a computer to function as the processing unit of the notification apparatus according to any one of Clauses 1 to 4.

Although the embodiment has been described above, the present invention is not limited to a specific embodiment, and various modifications and changes can be made within the scope of the gist of the present invention described in the claims.

### REFERENCE SIGNS LIST

100 Notification system
110 Processing unit
120 Storage unit
130 Vehicle stop sensor
140 Reception unit
150 Communication unit
160 Notification unit
200 EV charger
210 Charging (discharging) circuit and charging control circuit
300 EV
400 Device
500 Vehicle connector
600 Charging cable
700 Power line
1000 Drive device
1001 Recording medium
1002 Auxiliary storage device
1003 Memory device
1004 CPU
1005 Interface device
1006 Display device
1007 Input device
1008 Output device

1. A notification apparatus comprising:
circuitry configured to
detect that an electric vehicle has stopped;
detect that a vehicle connector has not been connected to the electric vehicle after locking a door of the electric vehicle;
determine that a user is promoted to connect the vehicle connector to the electric vehicle, upon detecting that the electric vehicle has stopped and detecting that the vehicle connector has not been connected to the electric vehicle; and
present a notification to the user to prompt the user to connect the vehicle connector.

2. The notification apparatus according to claim 1, wherein the circuitry is configured to determine whether the door of the electric vehicle has been locked using a control signal from a user device.

3. The notification apparatus according to claim 1, wherein the circuitry is configured to present the notification using light, a sound, text, vibration, or wireless communication.

4. The notification apparatus according to claim 1, wherein the circuitry is configured to determine whether the electric vehicle has stopped in a parking space based on a sensor signal from a sensor, the sensor signal indicating that the electric vehicle is stopped.

5. A system comprising:
the notification apparatus according to claim 1; and
the electric vehicle.

6. (canceled)

7. A notification method comprising:
detecting that an electric vehicle has stopped;
detecting that a vehicle connector has not been connected to the electric vehicle after locking a door of the electric vehicle;
determining that a user is promoted to connect the vehicle connector to the electric vehicle, upon detecting that the electric vehicle has stopped and detecting that the vehicle connector has not been connected to the electric vehicle; and
presenting a notification to the user to prompt the user to connect the vehicle connector.

8. A non-transitory computer medium storage medium storing a program configured for causing a computer to execute the notification method of claim 7.
